(19) United States
(12) Patent Application Publication
(10) Pub. No.: US 2015/0124007 A1
(43) Pub. Date: May 7, 2015

(54) STEREOSCOPIC IMAGE DISPLAY SYSTEM

(71) Applicant: Shenzhen China Star Optoelectronics Technology Co. Ltd., Shenzhen (CN)

(72) Inventor: Chia-Yu Lee, Shenzhen (CN)

(21) Appl. No.: 13/704,629

(22) PCT Filed: Aug. 20, 2012
(86) PCT No.: PCT/CN12/80337

§ 371 Date: Dec. 17, 2012

(30) Foreign Application Priority Data
Jul. 26, 2012 (CN) 201210261648.5

(51) Int. Cl. G09G 3/36; G02B 27/26

(52) U.S. Cl. CPC G09G 3/3607; G02B 27/26; G09G 2310/027; G09G 2320/0209
USPC 345/691; 345/58; 345/89

(57) ABSTRACT

A stereoscopic image display system is described. The stereoscopic image display system includes a plurality of first pixel rows and second pixel rows, wherein a first gray level voltage is inputted to first pixel rows for displaying first image frame and first black image voltage is inputted to second pixel rows for displaying first black image frame during current frame period, and second gray level voltage is inputted to second pixel rows for displaying second image frame and second black image voltage is inputted to first pixel rows for displaying a second black image frame during next frame period; and a film-type patterned retarder including first phase difference region corresponding to first pixel rows and second phase difference region corresponding to second pixel rows. The stereoscopic image display system correspondingly arranges the frame rate to the black insertion lines to solve the problem of image crosstalk.

### FIELD OF THE INVENTION

The present invention relates to an image display technique, and more particularly to a stereoscopic image display system.

### BACKGROUND OF THE INVENTION

Please refer to FIG. 1. FIG. 1 is a schematic view of a conventional stereoscopic image display system. The conventional stereoscopic image display system utilizes the pattern retarder technique adapted to polarized glasses to display three-dimensional image. As shown in FIG. 1, a linear polarized plate is disposed on one side of the display panel (not shown) in the display apparatus and a λ/4 array retarder plate 12 is disposed on one side of the color filter (not shown). The light emitted from the backlight module of the display system passes through the linear polarized plate 10 to form linear polarized light beam. Since the light axis of the linear polarized plate 10 is vertical to the horizontal direction “H”, only the polarized light along the vertical direction can passes through the linear polarized plate 10. That is, the light passing through the linear polarized plate 10 is vertical polarized light. Moreover, the light axes include two types including one light axis of 45 degrees relative to the horizontal direction “H” and the other light axis of 135 degrees relative to the horizontal direction “H”. Such the two light axes are interlaced along the vertical direction, as shown in FIG. 1. Therefore, the vertical polarized light from the linear polarized plate 10 passes the λ/4 array retarder plate 12 to form the left-hand circularly polarized light and the right-hand circularly polarized light. The left-hand circularly polarized light from the λ/4 array retarder plate 12 passes the right-hand glass of the polarized glasses 14 to be observed by the viewer wherein the left-hand circularly polarized light is absorbed by left-hand glass not to be observed by the viewer. The right-hand circularly polarized light from the λ/4 array retarder plate 12 passes the left-hand glass of the polarized glasses 14 to be observed by the viewer wherein the right-hand circularly polarized light is absorbed by right-hand glass not to be observed by the viewer. Therefore, the left eye and right eye of the viewer can receive different images respectively to see the three-dimensional image.

FIG. 2 is a schematic view of a stereoscopic image display system having a film-type patterned retarder (FPR) with (¼)λ 21. As shown in FIG. 2, based on the three-dimensional image, the color filter 23 includes left-hand color region 23L for displaying left-hand image and right-hand color region 23R for displaying right-hand image. The black matrixes (BM) 22 are disposed in the left-hand color region 23L and the right-hand color region 23R to prevent dark status from light leak. The left-hand color region 23L and the right-hand color region 23R correspond to one phase difference region 21L and the other phase difference region 21R. When the image signal is transmitted from the left-hand color region 23L adjacent to the BM 22 and enter the glass substrate, the image light is emitted to the phase difference region 21R of the film-type patterned retarder (FPR) with (¼)λ 21. Thus, the emitted angle of the image light is greater than a predetermined angle “θ” so that the image light from the left-hand color region 23L enters the retarder film 142 of the polarized glasses 14 to be viewed from the left eye corresponding to the left-hand glass and the image light from the right-hand color region 23R enters the retarder film 141 of the polarized glasses 14 to be viewed from the right eye corresponding to the right-hand glass, which causes the image crosstalk. Consequently, there is a need to develop an image display system to solve the problem of the image crosstalk.

### SUMMARY OF THE INVENTION

One objective of the present invention is to provide a stereoscopic image display system for increasing the vertical visual field angle to solve the problem of image crosstalk when the frame rate, i.e. the reciprocal of frame period, of the LCD panel is correspondingly arranged to the black insertion lines.

According to the above objective, the present invention sets forth a stereoscopic image display system. The stereoscopic image display system includes a liquid crystal display panel having a plurality of first pixel rows and a plurality of second pixel rows, wherein a first gray level voltage is correspondingly inputted to the first pixel rows for displaying a first image frame and a first black image voltage is inputted to the second pixel rows for displaying a first black image frame during a current frame period, and a second gray level voltage is correspondingly inputted to the second pixel rows for displaying a second image frame and a second black image voltage is inputted to the first pixel rows for displaying a second black image frame during a next frame period; a first polarized plate disposed on one side of the liquid crystal display panel; a second polarized plate disposed on the other side opposite to the one side of the liquid crystal display panel; and a film-type patterned retarder disposed on one side of the second polarized plate, wherein the film-type patterned retarder comprises a first phase difference region corresponding to the first pixel rows and a second phase difference region corresponding to the second pixel rows.

In one embodiment, each of the second pixel rows of the first black image frame is formed by a first black insertion line for sheltering a polarized light passing through the first polarized plate and corresponding to the second pixel rows during the current frame period.

In one embodiment, the first black insertion lines are interlaced with the first pixel rows of the first image frame.

In one embodiment, the first black insertion lines correspond to the second phase difference region.

In one embodiment, each of the first pixel rows of the second black image frame is formed by a second black insertion line for sheltering a polarized light passing through the first polarized plate and corresponding to the first pixel rows during the next frame period.

In one embodiment, the second black insertion lines are interlaced with the second pixel rows of the second image frame.

In one embodiment, the second black insertion lines correspond to the first phase difference region.

In one embodiment, a light beam corresponding to the first image frame passes through the second polarized plate and the first phase difference region of the film-type patterned retarder for forming a left-hand circularly polarized light during the current frame period, and a light beam corresponding to the second image frame passes through the second polarized plate and the second phase difference region of the film-type patterned retarder for forming a right-hand circularly polarized light during the next frame period.

In one embodiment, the current frame period is defined as a display time interval between the first image frame and the second image frame.

In one embodiment, the current frame period and the next frame period are less than or equal to 8.3 millisecond (ms).

In one embodiment, the stereoscopic image display system further includes a color filter disposed on the other side of the second polarized plate and opposite to the film-type patterned retarder wherein the color filter further comprises a first filter unit and a second filter unit corresponding to the first phase difference region and the second phase difference region respectively.

The present invention provides a stereoscopic image display system for increasing the vertical visual field angle to solve the problem of image crosstalk when the frame rate of the LCD panel is correspondingly arranged to the black insertion lines.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of a conventional stereoscopic image display system;

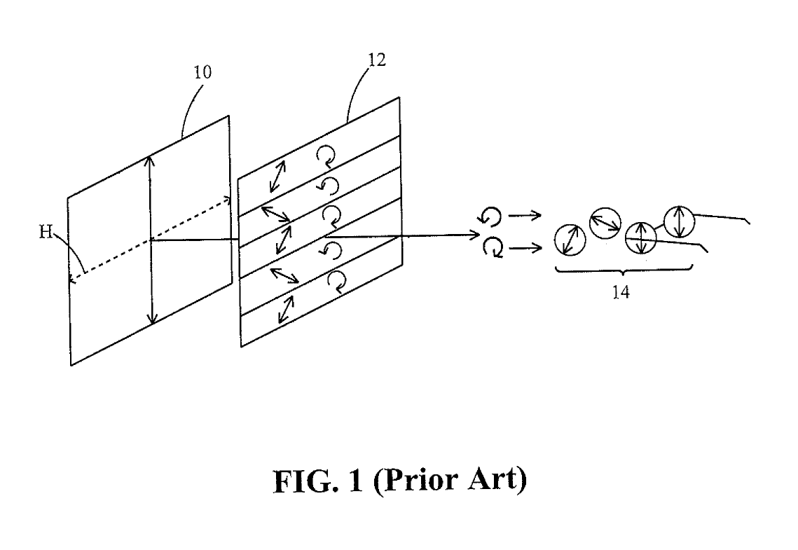

FIG. 2 is a schematic view of a stereoscopic image display system having a film-type patterned retarder (FPR) with (¼)λ;

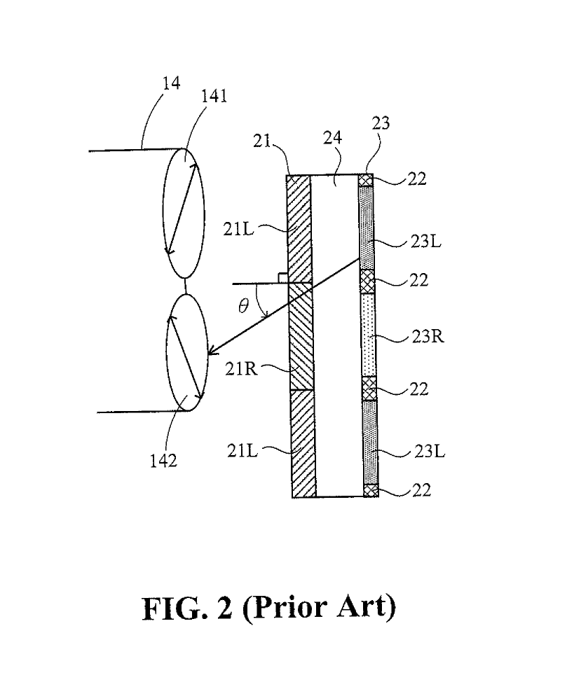

FIG. 3 is a schematic view of a stereoscopic image display system adapted to polarized glasses according to one embodiment of the present invention;

FIG. 4A is a schematic status view of driving a liquid crystal display panel during a current frame period according to one embodiment of the present invention;

FIG. 4B is a schematic status view of driving a liquid crystal display panel during a next frame period according to one embodiment of the present invention; and

FIG. 5 is a schematic timing view of a driving period of the liquid crystal display panel according to one embodiment of the present invention.

### DETAILED DESCRIPTION OF THE PREFERRED EMBODIMENTS

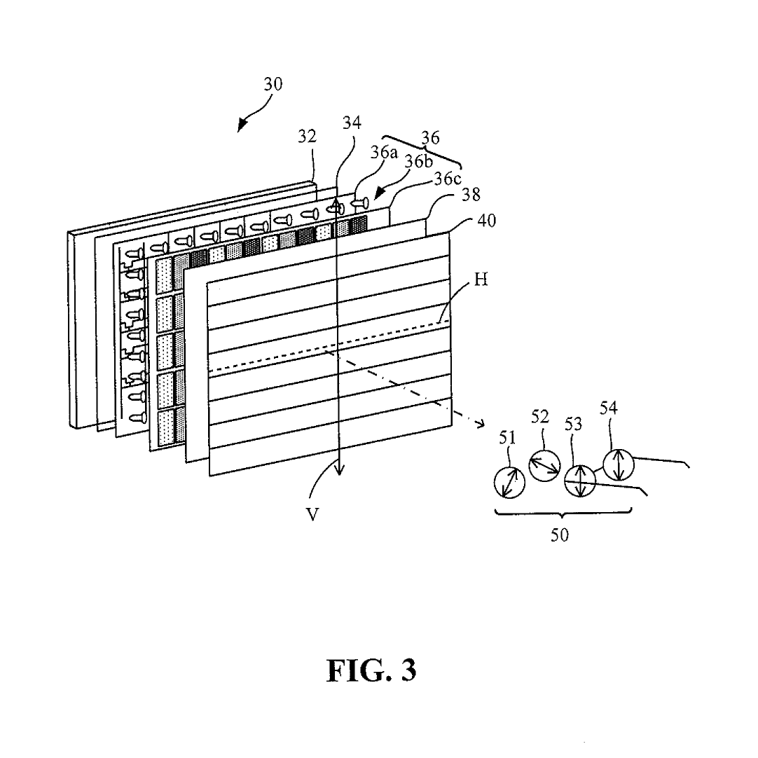

Please refer to FIG. 3. FIG. 3 is a schematic view of a stereoscopic image display system 30 adapted to polarized glasses 50 according to one embodiment of the present invention. As shown in FIG. 3, the stereoscopic image display system 30 includes a backlight module 32, a first polarized plate 34, a liquid crystal display (LCD) panel 36, a second polarized plate 38 and a film-type patterned retarder 40. The backlight module 32 serves as backlight source, such as cold cathode fluorescent lamp (CCFL), direct-type light-emitted diode (LED) and edge LED.

As shown in FIG. 3, the LCD panel 36 is a panel for displaying the image and includes a plurality of pixel rows wherein each of the pixel rows has a plurality of pixel units. In one embodiment, the light incidence side and the light-emitting side of the LCD panel 36 include the first polarized plate 34 and the second polarized plate 38 respectively. In other words, the first polarized plate 34 is disposed between the backlight module 32 and the LCD panel 36 and the second polarized plate 38 is disposed between the LCD panel 36 and the film-type patterned retarder 40. The first polarized plate 34 is used to polarize the backlight from the backlight module 32. The second polarized plate 38 can polarize the light beam passing through the LCD panel 36 along the penetration direction “V” to form vertically polarized light wherein the penetration direction “V” is vertical to the horizontal direction “H”.

As shown in FIG. 3, the LCD panel 36 includes a thin-film transistor (TFT) array substrate 36a, a liquid crystal 36b and a color filter 36c. The liquid crystal 36b is disposed between the TFT array substrate 36a and the color filter 36c. In FIG. 3, the TFT array substrate 36a is disposed between the first polarized plate 34 and the liquid crystal 36b. The thin-film transistors on the TFT array substrate 36a can control the twisted status of liquid crystal molecules in the liquid crystal 36b for changing the polarized angle of the liquid crystal molecules.

In FIG. 3, the color filter 36c is disposed in one side of the TFT array substrate 36a and disposed between the liquid crystal 36b and the film-type patterned retarder 40 for generating the color change of polarized light. As shown in FIG. 3, the film-type patterned retarder 40 is disposed in one side of the second polarized plate 38. The vertical polarized light penetrating through the second polarized plate 38 passes the film-type patterned retarder 40 to form the left-hand circularly polarized light and the right-hand circularly polarized light.

The polarized glasses 50 is composed of left-hand polarized glass 53, right-hand polarized glass 54 and polarized films 51, 52 attached on the left-hand polarized glass 53, right-hand polarized glass 54.

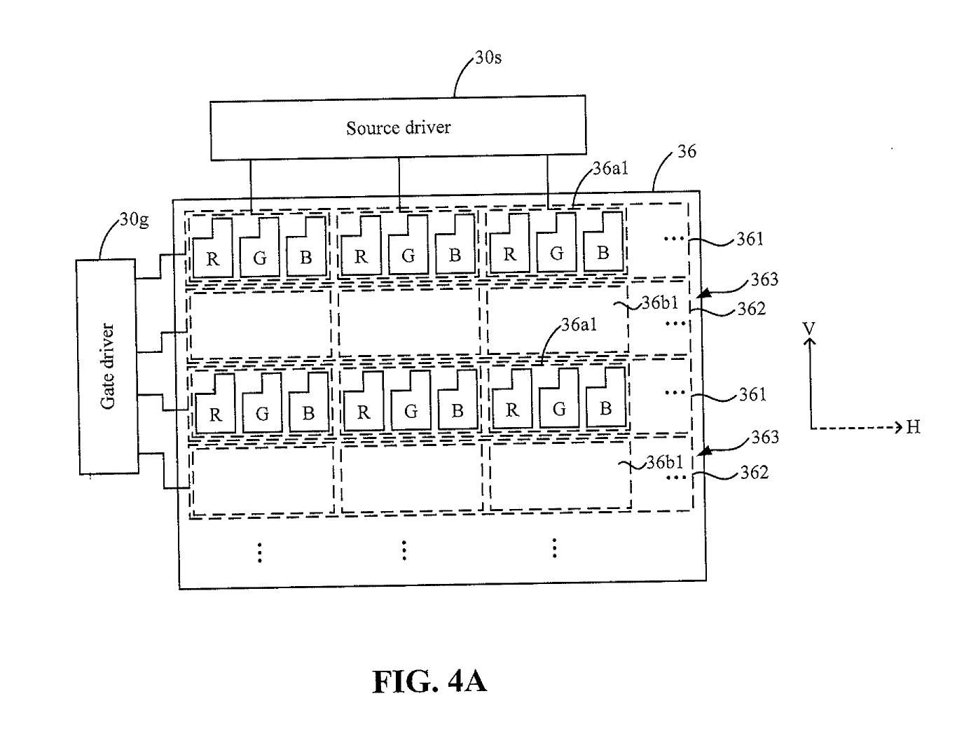

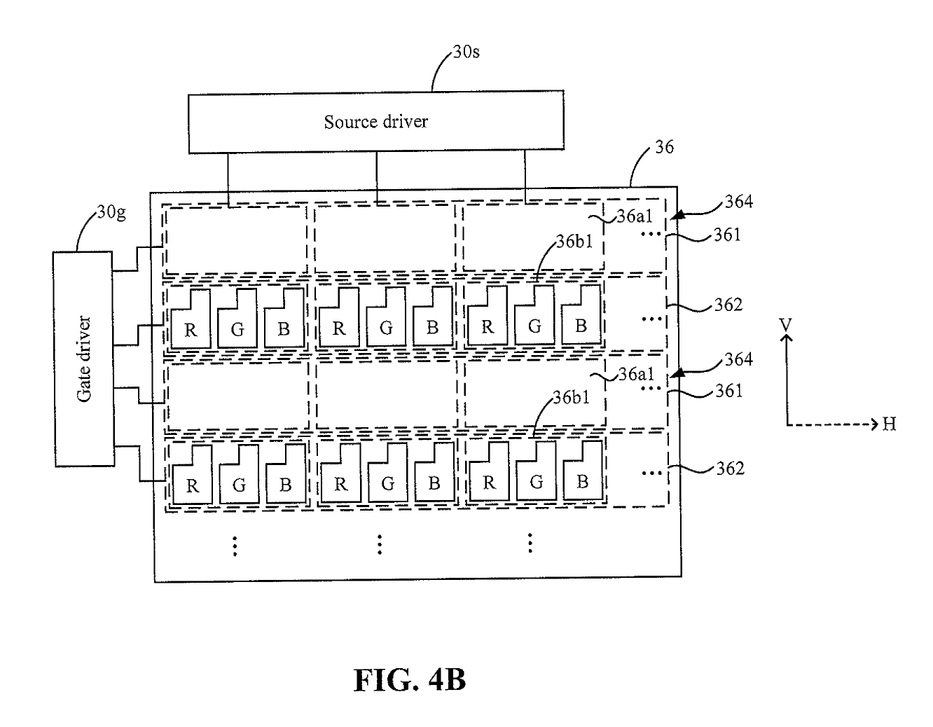

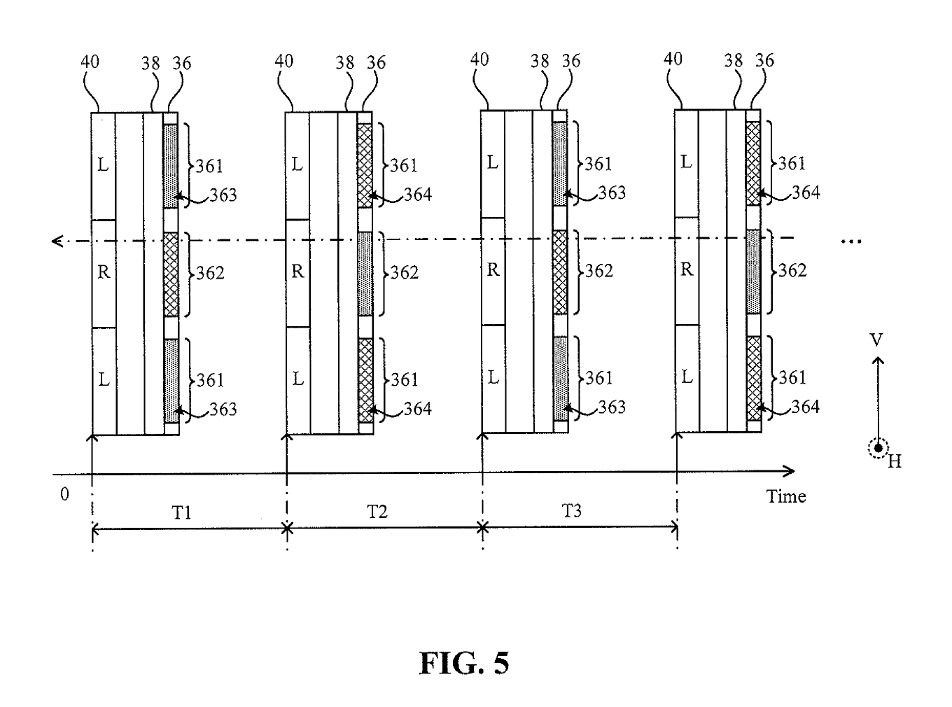

FIG. 4A is a schematic status view of driving a liquid crystal display panel 36 during a current frame period according to one embodiment of the present invention. FIG. 4B is a schematic status view of driving a liquid crystal display panel 36 during a next frame period according to one embodiment of the present invention. FIG. 5 is a schematic timing view of a driving period of the liquid crystal display panel 36 according to one embodiment of the present invention. The horizontal direction “H” represents a direction which penetrates out of the figure plane in FIG. 5. As shown in the LCD panel 36 of FIG. 4A and FIG. 4B, the liquid crystal display panel 36 has a plurality of first pixel rows 361 and a plurality of second pixel rows 362 which are alternately arranged in parallel along the penetration direction “V” wherein the penetration direction “V” is vertical to the horizontal direction “H”.

A first gray level voltage is correspondingly inputted to the first pixel rows 361 for displaying a first image frame and a first black image voltage is inputted to the second pixel rows 362 for displaying a first black image frame during a current frame period T1. A second gray level voltage is correspondingly inputted to the second pixel rows 362 for displaying a second image frame and a second black image voltage is inputted to the first pixel rows 361 for displaying a second black image frame during a next frame period T2.

The current frame period T1 is defined as a display time interval between the first image frame and the second image frame. The next frame period T2 is defined as a display time interval between the second image frame and the first image frame. In one embodiment, the current frame period and the next frame period are less than or equal to 8.3 millisecond (ms). A frame rate is defined as the reciprocal of current frame period T1 and next frame period T2 respectively. Preferably, the frame rate is either greater than or equal to 120 Hz. In one embodiment, the frame period T3 is equal to current frame period T1.

As shown in FIG. 5, the film-type patterned retarder 40 includes a first phase difference region “L” corresponding to the first pixel rows 361 and a second phase difference region “R” corresponding to the second pixel rows 362. In other words, the film-type patterned retarder 40 includes two different polarized directions so that the image projecting the left eye of viewer in the first phase difference region “L” has a first polarized direction and the image projecting to the right eye of viewer in the second phase difference region “R” has a second polarized direction by using proper structure. Further, the polarized glasses 50 allows the left-hand image with the first polarized direction to pass through the left-hand glass and the right-hand image with the second polarized direction to pass through the right-hand glass. Thus, when the viewer wears a pair of polarized glasses 50, left eye views the left-hand image provided by the display system and right eye views the right-hand image provided by the display system to improve the image cross-talk so that the view can easily observes the three-dimensional image.

Please continuously refer to FIG. 3, FIG. 4A and FIG. 4B. The TFT array substrate 36a receives the polarized light and each of the first pixel rows 361 and the second pixel rows 362 along the penetration direction “V” at a frame rate are sequentially and alternately and driven. That is, the TFT array substrate 36a drives each of the first pixel rows 361 during the current frame period and each of the second pixel rows 362 during the next frame period. Specifically, the LCD panel 36 writes the data signal into the first pixel rows 361 and the second pixel rows 362 by the line scanning manner. For example, the gate driver 30g of the stereoscopic image display system 30 drives the first pixel rows 361 of an image frame from the top to the bottom at the frame rate so that source driver 30s writes the displaying data into the first pixel regions 36a1 of the first pixel rows 361, e.g. the pixel electrodes with red, green and blue colors, as shown in FIG. 4A and FIG. 4B. Afterwards, the gate driver 30g of the stereoscopic image display system 30 drives the second pixel rows 362 of an image frame from the top portion to the bottom portion at a predetermined frame rate so that source driver 30s writes the displaying data into the second pixel regions 36b1 of the second pixel rows 362, e.g. the pixel electrodes with red, green and blue colors, as shown in FIG. 4A and FIG. 4B.

Each of the second pixel rows 362 of the first black image frame is formed by a first black insertion line 363 for sheltering a polarized light passing through the first polarized plate 34 and corresponding to the second pixel rows 362 during the current frame period T1. That is, the first black insertion lines 363 spaced apart in the LCD panel 36 forms the first black image frame. The first black insertion lines 363 are interlaced with the first pixel rows 361 of the first image frame wherein the first black insertion lines 363 correspond to the second phase difference region “R”.

Each of the first pixel rows 361 of the second black image frame is formed by a second black insertion line 364 for sheltering a polarized light passing through the first polarized plate 34 and corresponding to the first pixel rows 361 during the next frame period T2. That is, the second black insertion lines 364 spaced apart in the LCD panel 36 forms the first black image frame. The second black insertion lines 364 are interlaced with the second pixel rows 362 of the second image frame wherein the second black insertion lines 364 correspond to the first phase difference region “L”. A light beam corresponding to the first image frame passes through the second polarized plate 38 and the first phase difference region “L” of the film-type patterned retarder 40 for forming a left-hand circularly polarized light during the current frame period T1. A light beam corresponding to the second image frame passes through the second polarized plate 38 and the second phase difference region “R” of the film-type patterned retarder 40 for forming a right-hand circularly polarized light during the next frame period T2.

The image projecting to the right eye of viewer in the second phase difference region “R” is not overlapped with the image projecting the left eye of viewer in the first phase difference region “L”. Similarly, the image projecting the left eye of viewer in the first phase difference region “L” is not overlapped with the image projecting to the right eye of viewer in the second phase difference region “R”.

In one embodiment, the stereoscopic image display system further includes a color filter 36c disposed on the other side of the second polarized plate 38 and opposite to the film-type patterned retarder 40 wherein the color filter 36c further includes a first filter unit and a second filter unit corresponding to the first phase difference region “L” and the second phase difference region “R” respectively.

According to above-mentioned descriptions, the stereoscopic image display system to solve the problem of image crosstalk. When the frame rate, i.e. the reciprocal of frame period, of the LCD panel is correspondingly arranged to the black insertion lines, the left-hand image and the right-hand image are transmitted in different frame periods, i.e. the reciprocals of the current and next frame periods, to prevent the overlapped status between the left-hand image and the right-hand image for increasing the vertical visual field angle.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A stereoscopic image display system, comprising:
a liquid crystal display panel having a plurality of first pixel rows and a plurality of second pixel rows, wherein a first gray level voltage is correspondingly inputted to the first pixel rows for displaying a first image frame and a first black image voltage is inputted to the second pixel rows for displaying a first black image frame during a current frame period, and a second gray level voltage is correspondingly inputted to the second pixel rows for displaying a second image frame and a second black image voltage is inputted to the first pixel rows for displaying a second black image frame during a next frame period;
a first polarized plate disposed on one side of the liquid crystal display panel;
a second polarized plate disposed on the other side opposite to the one side of the liquid crystal display panel; and
a film-type patterned retarder disposed on one side of the second polarized plate, wherein the film-type patterned retarder comprises a first phase difference region corresponding to the first pixel rows and a second phase difference region corresponding to the second pixel rows.

2. The stereoscopic image display system of claim 1, wherein each of the second pixel rows of the first black image frame is formed by a first black insertion line for sheltering a polarized light passing through the first polarized plate and corresponding to the second pixel rows during the current frame period.

3. The stereoscopic image display system of claim 2, wherein the first black insertion lines are interlaced with the first pixel rows of the first image frame.

4. The stereoscopic image display system of claim 2, wherein the first black insertion lines correspond to the second phase difference region.

5. The stereoscopic image display system of claim 1, wherein each of the first pixel rows of the second black image frame is formed by a second black insertion line for sheltering a polarized light passing through the first polarized plate and corresponding to the first pixel rows during the next frame period.

6. The stereoscopic image display system of claim 5, wherein the second black insertion lines are interlaced with the second pixel rows of the second image frame.

7. The stereoscopic image display system of claim 5, wherein the second black insertion lines correspond to the first phase difference region.

8. The stereoscopic image display system of claim 1, wherein a light beam corresponding to the first image frame passes through the second polarized plate and the first phase difference region of the film-type patterned retarder for forming a left-hand circularly polarized light during the current frame period, and a light beam corresponding to the second image frame passes through the second polarized plate and the second phase difference region of the film-type patterned retarder for forming a right-hand circularly polarized light during the next frame period.

9. The stereoscopic image display system of claim 1, wherein the current frame period is defined as a display time interval between the first image frame and the second image frame.

10. The stereoscopic image display system of claim 1, wherein the current frame period and the next frame period are less than or equal to 8.3 millisecond (ms).

11. The stereoscopic image display system of claim 1, further comprising a color filter disposed on the other side of the second polarized plate and opposite to the film-type patterned retarder wherein the color filter further comprises a first filter unit and a second filter unit corresponding to the first phase difference region and the second phase difference region respectively.
